(19) United States
(12) Patent Application Publication
(10) Pub. No.: US 2011/0185545 A1
(43) Pub. Date: Aug. 4, 2011

(54) Utility hanger

(76) Inventor: Kenneth Lee Reitzel, Edon, OH (US)

(21) Appl. No.: 12/657,972

(22) Filed: Feb. 1, 2010

(51) Int. Cl. F16B 2/10

(52) U.S. Cl. 24/510

(57) ABSTRACT

A device for hanging bird feeders, wind chimes and similar objects from the limbs of trees having two opposed jaws that are spring closed.

### BACKGROUND OF THE INVENTION

The present invention relates to devices for hanging articles from the limbs or branches of trees. A need exists for a device that will securely hold a load, that is easy to use and does not harm the tree.

### SUMMARY OF THE INVENTION

The present invention provides a device that can easily be attached to a tree limb up to three inches in diameter. The invention presented is a pair of opposed pivoting spring-loaded jaws that forming a hanger that encircles the tree limb and provides a means of attaching a device such as a bird feeder or wind chime.

### BRIEF DESCRIPTION OF THE SEVERAL DRAWINGS

FIG. 1 is a plan view of the invention.

FIG. 2 is a perspective view of the invention.

FIG. 3 is an exploded view of the invention.

FIG. 4 is plane view of one the jaws of the invention.

FIG. 5 is a perspective view of one of the jaws of the invention.

FIG. 6 is an edge on view of one of the jaws of the invention.

### DETAILED DESCRIPTION OF THE INVENTION

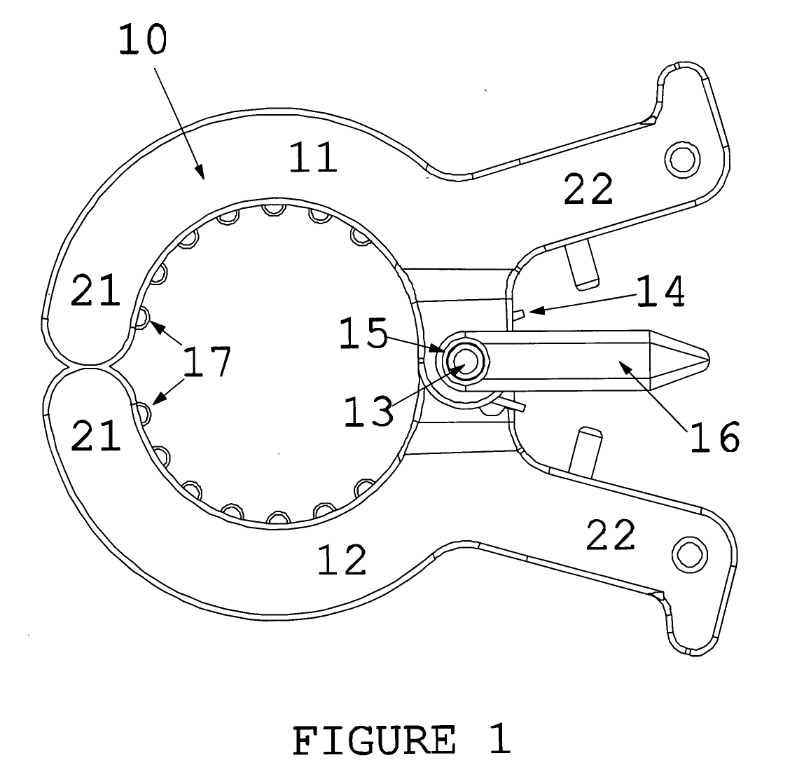

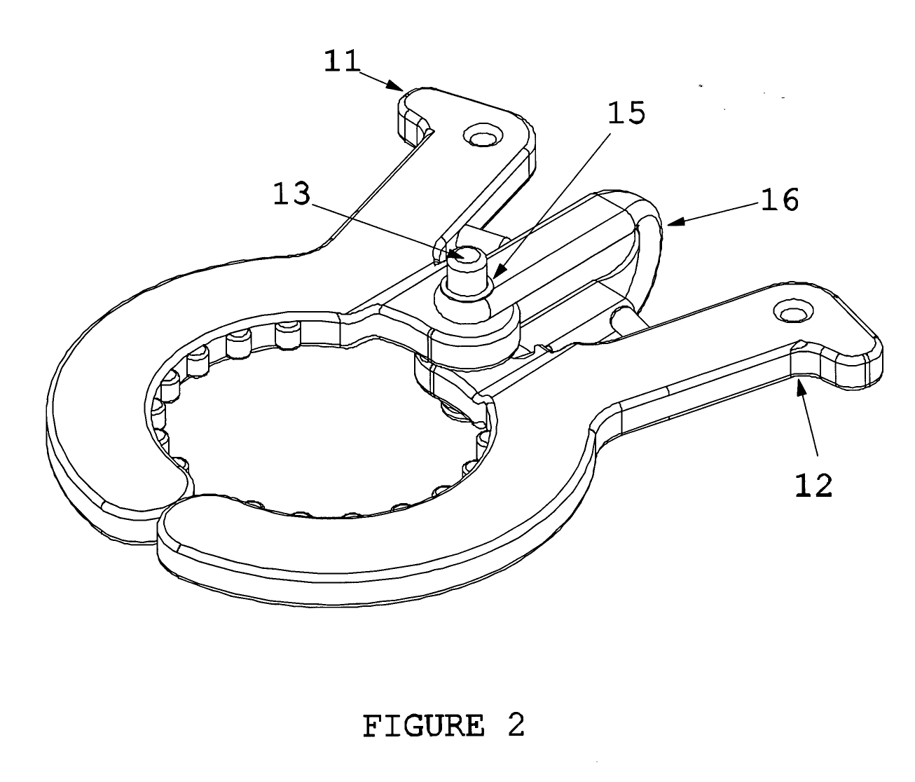

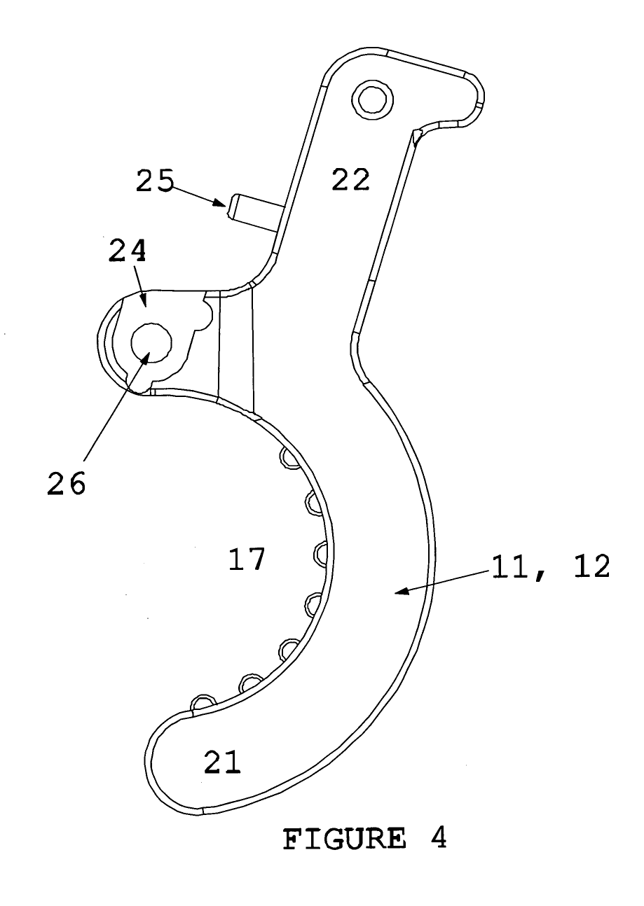

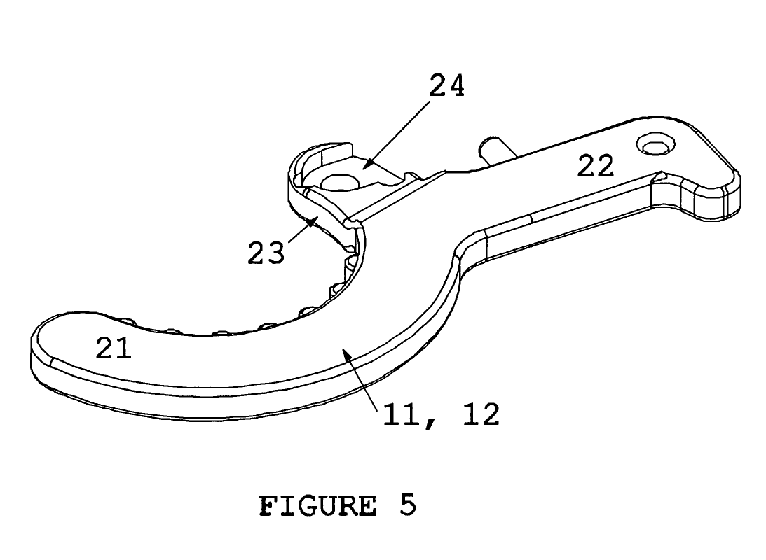

Referring to FIGS. 1 and 2, the assembled Hanger 10 and its main components can be seen. The Hanger 10 comprises a Left Arm 11, a Right Arm 12, a Pivot Pin 13, a Torsion Spring 14, a Locking Ring 15, and a Clevis 16. The arms of the Hanger 10 are identical and a single arm can been seen in FIGS. 4 and 5. The arms 11 and 12 have a Jaw 21, a plurality of inward facing Teeth 17, a Handle 22, an offset Extension 23, a Spring Pocket 24 and a Stop 25. The Handle 22 protrudes at an angle of approximately 15 degrees from the centerline of the Hanger 10. The angle of the Handle 22 is set so that when the Jaws 11 and 12 are fully open against the Stops 25, there is sufficient space between the tips of the Jaws 21 to allow the Hanger 10 to be placed over a three inch diameter branch.

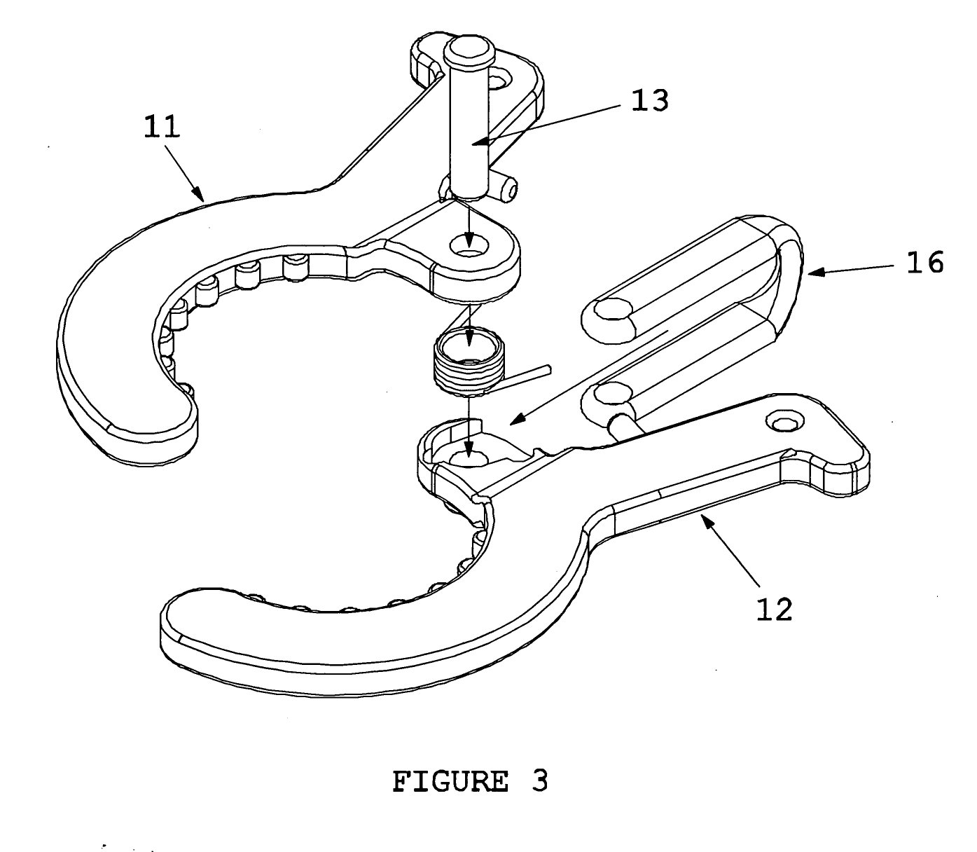

When the Hanger 10 is assembled, the Arms 11 and 12 are juxtaposed and secured together using the Pivot Pin 13 and the Locking Ring 15 as shown in FIG. 2. The Clevis 16 and the Torsion Spring 14 are also secured to the Hanger 10 by the Pivot Pin 13 as shown in FIGS. 2 and 3. The Hanger 10 is operated by squeezing the Handles 22 toward each other, forcing the Arms 11 and 12 open. The Arms 11 and 12 are then secured around a tree limb or other such object and the force on the Handles 22 is released, allowing the Arms 11 and 12 to close due to the pressure exerted upon them by the Torsion Spring 14. A Stop 25 provided on each Handle 22 prevents the Hanger 10 from opening beyond a predetermined distance.

An important element of the inventiveness and functionality of the Hanger 10 is the shape of the Jaws 21 and the placement of the Pivot Pin 13 and how these elements shape the force vectors on the Arms 11 and 12. Referring to FIG. 1, it can be seen that the opening described by the Arms 11 and 12 when the Jaws 21 just meet, is roughly semicircular. The Jaws 21 extend beyond a point that would describe a full one hundred eighty degree semicircle. When in use, a load such as a bird house or wind chime will be secured with a chain or rope or other means to the Clevis 16. The force from the load secured to the Clevis 16 will be transmitted to the Jaws 11 along a centerline drawn though the center of the Pivot Pin 13, assuming the Hanger 10 is centered on the branch, which will be it's natural position, to the point where the Jaws 21 intersect. When the Hanger 10 is used on a three inch or smaller diameter branch the Jaws 21 overlap. The Teeth 17 engage with the branch thereby transmitting the force due to the load on the Clevis 17 upward into the Jaws 21. The shape of the Teeth 17 allows very little of the force due to the load to be transmitted perpendicularly, i.e. in a direction forcing the Jaws 11 and 12 open. The majority of the force will be transmitted in a direction directly opposite to the force due to the load. A semicircular shape was chosen for the Teeth 17 to minimize damage to the tree branch upon which the Hanger 10 will be placed.

The semicircular shape of the Jaws 21 transmits the force from the load to the Hanger 10 along a force vector with a vertical component proportional to the sine of an angle described by a line running from the center of the opening described by the Jaws 21 to the tips of the Jaws 21, and a horizontal component proportional to the cosine of the same angle. As the Jaws 21 move to a more open position, the force from the load acting in the horizontal direction which tends to force the jaws open, becomes smaller. At the same time, the force on the Jaws 11 and 12 from the Torsion Spring 14, tending to force them in a closed direction becomes greater. The further open the Hanger 10 becomes due to the load on the Clevis 16, the less easily it opens while at the same time it the more it is forced closed by operation of the Torsion Spring 14. These force relationships remain constant throughout the usable range of the Hanger 10.

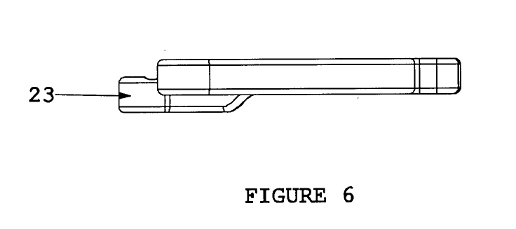

Referring to FIG. 6, the offset Extension 23 portions of the Jaws 21 can be seen. When the Jaws 11 and 12 are fitted onto the Pivot Pin 13, the Extensions 23 of each Jaw 21 are aligned next to each other, and allow a portion of the thickness of the Jaws 21 to occupy the same plane. This allows the tips of jaws to meet as shown in FIG. 2. The Jaws 21 are forced closed by the action of the Torsion Spring 14. The Jaws 21 loosely fit on the Pivot Pin 13 and are made of a flexible plastic so that instead of meeting at the tips when the Hanger 10 is closed, they may be made to slide past each other allowing the Hanger 10 to be easily clamped on successively decreasing diameters of branches.

Referring FIG. 5 the mechanism for transmitting force from the Torsion Spring 14 to each of the Jaws 21 can be seen. A Spring Pocket 24 is provided in each Extension 13 to hold the Torsion Spring 14. The Torsion Spring 14 used in the present invention can be seen in the exploded view of FIG. 3. The depth of the Spring Pocket 24 is sized to allow full engagement of one of the legs of the Torsion Spring 14 while allowing the body of the Torsion Spring 14 to extend out of the Spring Pocket 24 so the opposite leg of the Torsion Spring 14 may be fully engaged in the Spring Pocket 24 of the Extension 13 of the other Jaw 21. The legs of the Torsion Spring 14 push against a side of the Spring Pocket 24, thereby forcing the upper portion of the Jaws 21 together. The Torsion Spring 14 is sized to allow the Hanger 10 to be easily opened with one hand and to force the Jaws 21 and 12 closed from their full open position to a diameter of about one and a half inches.

Referring to FIG. 4, it can be seen that the Extension 23 is provided with a centrally located Pin Hole 26. The Pin Hole 26 is sized to accommodate the Pivot Pin 13 and leave sufficient clearance between the Pivot Pin 13 and the sides of the Pin Hole 26 so that the end of the Jaws 21 may slide past each other when the Hanger 10 is closed.

The invention having been completely described, what is claimed is:

1. A device for hanging articles from the limbs of trees comprising:
Two movable clamping arms arranged in a pivotal relationship with each other about a pin, each clamping arm comprising a distal jaw, a proximal handle, an inwardly extending center portion having an interior pocket for accepting the body of a spring and a centrally located opening therethrough for holding said pin, and means for pivoting said arms towards a closed position.

2. The device of claim 1 wherein said distal jaw is semicircular in shape wherein said inwardly extending portion is a proximal end of said jaw.

3. The device of claim 2 where said semicircular shape describes an arc in excess of 180 degrees.

4. The device of claim 1 wherein said means for pivoting said jaws closed is a spring.

5. The device of claim 4 wherein said spring is a torsion spring mounted on said pin, said spring having a first end resting in said pocket of said arm thereby engaging said arm and a second end resting in said pocket of the second arm thereby engaging the second arm.

6. The device of claim 2 wherein said inwardly extending center portion is offset from the plane of said clamping arm.

8. The device of claim 1 wherein said proximal handle is set at an outward angle from a center line of the jaw.

9. The device of claim 1 further comprising means for attaching a rope or chain.

10. The device of claim 9 wherein said means for attaching a rope is a clevis pivotally secured to said pin.

11. The device of claim 1 wherein said handle includes an inwardly pointing pin which will engage the same pin on the handle of said second arm thereby limiting the distance the handles may approach each other.
